(19) United States
(12) Patent Application Publication
(10) Pub. No.: US 2020/0101862 A1
(43) Pub. Date: Apr. 2, 2020

(54) CHARGING MANAGEMENT SYSTEM

(71) Applicant: SUBARU CORPORATION, Tokyo (JP)

(72) Inventors: Shinichi SAKAGUCHI, Tokyo (JP); Masaru OE, Tokyo (JP); Yudai MIAKE, Tokyo (JP)

(21) Appl. No.: 16/440,805

(22) Filed: Jun. 13, 2019

(30) Foreign Application Priority Data
Sep. 28, 2018 (JP) 2018-184489

(51) Int. Cl. B60L 53/66; B60L 53/30; H02J 7/00; B60L 58/10

(52) U.S. Cl. CPC B60L 53/665; B60L 58/10; H02J 7/0027; B60L 53/30

(57) ABSTRACT

A charging management system includes a battery, an onboard charger, and an electricity integrator. The battery is chargeable with electricity. The onboard charger is configured to supply electricity wirelessly received to the battery. The electricity integrator is configured to integrate an amount of electricity used for charging the battery.

### CROSS-REFERENCE TO RELATED APPLICATIONS

The present application claims priority from Japanese Patent Application No. 2018-184489 filed on Sep. 28, 2018, the entire contents of which are hereby incorporated by reference.

### BACKGROUND

The disclosure relates to a charging management system that manages charging of a battery.

There are vehicles that operate on electricity, such as electric automobiles. This type of vehicle includes a battery that can be charged by directly connecting a charging plug of a charging station with the battery (see, for example, Japanese Unexamined Patent Application Publication No. 2015-109780).

### SUMMARY

An aspect of the disclosure provides a charging management system including: a battery rechargeable with electricity; an onboard charger configured to supply electricity wirelessly received to the battery; and an electricity integrator configured to integrate an amount of electricity used for charging the battery.

### BRIEF DESCRIPTION OF THE DRAWINGS

The accompanying drawings are included to provide a further understanding of the disclosure and are incorporated in and constitute a part of this specification. The drawings illustrate example embodiments and, together with the specification, serve to explain the principles of the disclosure.

FIG. 1 is a block diagram schematically illustrating the configuration of a charging management system;

FIG. 2 is a flowchart illustrating the flow of a charging management method; and

FIG. 3 is a block diagram schematically illustrating the configuration of a charging management system.

### DETAILED DESCRIPTION

In the following, a preferred but non-limiting embodiment of the disclosure is described in detail with reference to the accompanying drawings. Note that sizes, materials, specific values, and any other factors illustrated in the embodiment are illustrative for easier understanding of the disclosure, and are not intended to limit the scope of the disclosure unless otherwise specifically stated. Further, elements in the following example embodiment which are not recited in a most-generic independent claim of the disclosure are optional and may be provided on an as-needed basis. Throughout the present specification and the drawings, elements having substantially the same function and configuration are denoted with the same reference numerals to avoid any redundant description. Further, elements that are not directly related to the disclosure are unillustrated in the drawings. The drawings are schematic and are not intended to be drawn to scale. In the case of directly connecting a charging station with a vehicle and charging a battery mounted on the vehicle, the amount of electricity output from the charging station and the amount of electricity input to the vehicle are substantially equal. Therefore, the amount of electricity with which the battery of the vehicle is charged can be determined by measuring the amount of electricity output from the charging station.

However, in the case of wirelessly charging the battery when the vehicle is stopped or traveling, the amount of electricity with which the battery is charged varies depending on the position and attitude of the vehicle, and the electricity supply side cannot determine the exact amount of electricity used for charging. In such a case, if the electricity supply side unilaterally performs billing, the user may develop a sense of distrust due to the difference between the amount of electricity output from electricity supply equipment and the amount of electricity with which the vehicle is actually charged.

It is desirable to provide a charging management system capable of determining the amount of electricity with which a vehicle is actually charged, and appropriately performing billing.

[Charging Management System 10]

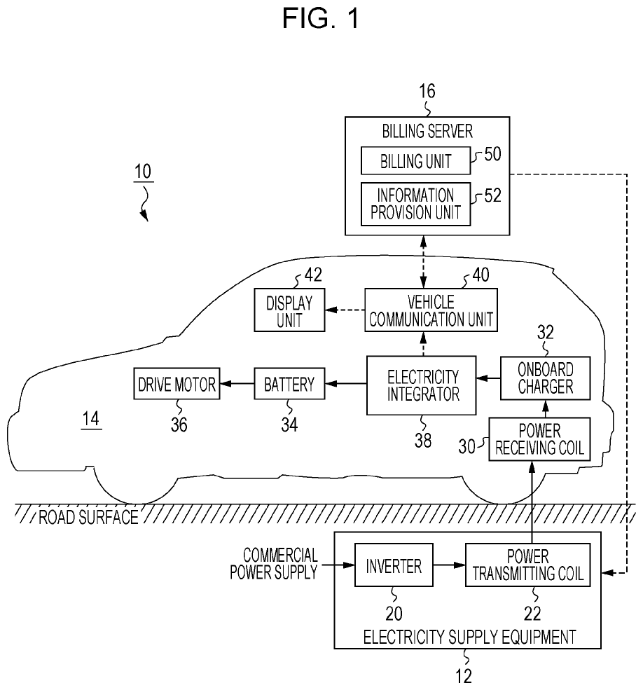

FIG. 1 is a block diagram schematically illustrating the configuration of a charging management system 10. In FIG. 1, the flow of electricity is indicated by the solid arrows, and the flow of signals (information) is indicated by the broken arrows. The charging management system 10 includes electricity supply equipment 12, a vehicle 14, and a billing server 16.

In the charging management system 10, electricity is wirelessly supplied from the electricity supply equipment 12 to the vehicle 14, and the vehicle 14 itself measures the supply state of the electricity, and the billing server 16 bills the vehicle 14 based on the measurement result (integration information described below).

[Electricity Supply Equipment 12]

The electricity supply equipment 12 is installed on (embedded in) the surface of a road, a parking lot, or other places, and includes an inverter 20 and a power transmitting coil 22. The inverter 20 converts AC power of a commercial power supply into AC power having a frequency higher than a commercial frequency. The power transmitting coil 22 is coupled to the inverter 20, and produces an electric field therearound as the AC power is supplied from the inverter 20.

[Vehicle 14]

The vehicle 14 includes a power receiving coil 30, an onboard charger 32, a battery 34, a drive motor 36, an electricity integrator 38, a vehicle communication unit 40, and a display unit 42. Although the vehicle 14 of the present embodiment is illustrated as an electric automobile having the drive motor 36 as a drive source, the present embodiment is applicable to a hybrid electric automobile having an engine together with the drive motor 36 as drive sources.

The power receiving coil 30 is disposed at the bottom of the vehicle 14. When facing the power transmitting coil 22, the power receiving coil 30 wirelessly receives electricity through electromagnetic induction with the power transmitting coil 22, and generates AC power. The expression “wirelessly receive electricity” means that electricity is supplied without electrical contact, regardless of whether a power transmitting device and a power receiving device are in physical contact in supplying electricity. The onboard charger 32 receives electricity from the power receiving coil 30, and supplies the electricity in the form of DC power to the battery 34.

However, the onboard charger 32 supplies electricity in the form of DC power to the battery 34, which is limited to when the driver wants to charge the battery 34 with electricity using the charging management system 10, that is, to when a switch for wireless charging is ON. Accordingly, if the driver has a contract for wireless charging with the billing service provider of the billing server 16 and the switch for wireless charging is ON, wireless charging automatically starts when the vehicle 14 moves to a position facing the power transmitting coil 22.

The battery 34 is a high-voltage (for example, 200 V) secondary battery, such as a lithium ion battery, and is charged with (stores) electricity supplied from the onboard charger 32. The drive motor 36 receives supply of electricity from the battery 34, and drives the vehicle 14 with the torque corresponding to the electricity supplied.

The electricity integrator 38 integrates the amount of electricity (Wh) used for charging the battery 34. For example, as illustrated in FIG. 1, the electricity integrator 38 is disposed on a power line connecting the onboard charger 32 with the battery 34, and integrates the amount of electricity based on the electric current passed the power line and the inter-line voltage. The electricity integrator 38 transmits integration information indicating the result of integrating the amount of electricity to the vehicle communication unit 40 wirelessly (via WiFi, Bluetooth (registered trademark), LTE, or the like). The electricity integrator 38 may calculate the amount of electricity based on the difference in State of Charge (SOC), that is, the amount of electricity with which the battery 34 is actually charged, between start of charging and completion of charging, or may integrate the amount of electricity input to the onboard charger 32.

The vehicle communication unit 40 transmits the integration information received from the electricity integrator 38 to the billing server 16, together with a billing identifier and a vehicle identifier. The billing identifier is an identifier that identifies a billing destination based on charging by the charging management system 10, such as a credit card of the driver who owns the vehicle 14. The vehicle identifier is an identifier that identifies the vehicle 14 provided with the vehicle communication unit 40.

The vehicle communication unit 40 uses the technology such as the technology of Electronic Toll Collection System 2.0 (ETC 2.0) to wirelessly and independently transmit high-security information such as personal information. The vehicle communication unit 40 using ETC 2.0 technology can transmit, in addition to information on entrance to and exit from freeways and credit card information, various types of information generated by the vehicle 14 to a management server of ETC 2.0 (not illustrated), with use of a gateway function of ETC 2.0.

The vehicle communication unit 40 is independently under security protection, and therefore the other function units of the vehicle 14 do not have high security measures. However, the existing protection for information may be implemented between the electricity integrator 38 and the vehicle communication unit 40 using an authenticator.

Accordingly, the vehicle communication unit 40 first establishes wireless communication with the management server of ETC 2.0, establishes communication with the billing server 16 via the management server of ETC 2.0, and then transmits the integration information, the billing identifier, and the vehicle identifier to the billing server 16. Once the vehicle communication unit 40 establishes communication with the billing server 16 via the management server of ETC 2.0, then the vehicle can communicate with the billing server 16 without being aware of the management server of ETC 2.0.

In some cases, the communication area where communication between the vehicle communication unit 40 and the management server of ETC 2.0 can be established is limited. For example, if the electricity supply equipment 12 includes a plurality of power transmitting coils 22 arranged along a road (this type of lane for wireless charging is hereinafter referred to as a wireless charging lane), the communication area is provided at least at a position where the wireless charging lane ends (end point). The communication area may be provided in various positions on the wireless charging lane other than this position, such as the start point of the wireless charging lane.

The vehicle communication unit 40 updates the integration information while located outside the communication area. Then, when the vehicle 14 enters the communication area, the vehicle communication unit 40 transmits the latest integration information, the billing identifier, and the vehicle identifier to the billing server 16.

The vehicle communication unit 40 can receive billing information from the billing server 16 via the management server of ETC 2.0 in the same manner as when transmitting the integration information, the billing identifier, and the vehicle identifier. The billing information is information indicating the price (fee) for charging for which the billing destination is billed.

The display unit 42 may be a car navigation system, a multi-function display (MFD), or any other suitable device, and displays the billing information acquired by the vehicle communication unit 40 in a manner such that the billing information is recognizable by the driver. The display unit 42 may display the integration information integrated by the electricity integrator 38, in addition to or in place of the billing information.

[Billing Server 16]

The billing server 16 includes a billing unit 50 and an information provision unit 52. As described above, the billing server 16 establishes communication with the vehicle communication unit 40 via the management server of ETC 2.0.

The billing unit 50 generates billing information based on the integration information, and bills the billing destination identified by the billing identifier. In this step, the billing unit 50 may determine whether the vehicle identifier received with the billing identifier is the vehicle identifier associated in advance with the billing identifier. In the case where the fee has not been paid based on the generated billing information, the billing unit 50 can suspend feeding of electricity from the electricity supply equipment 12. The information provision unit 52 transmits the thus generated billing information to the vehicle communication unit 40.

[Charging Management Method]

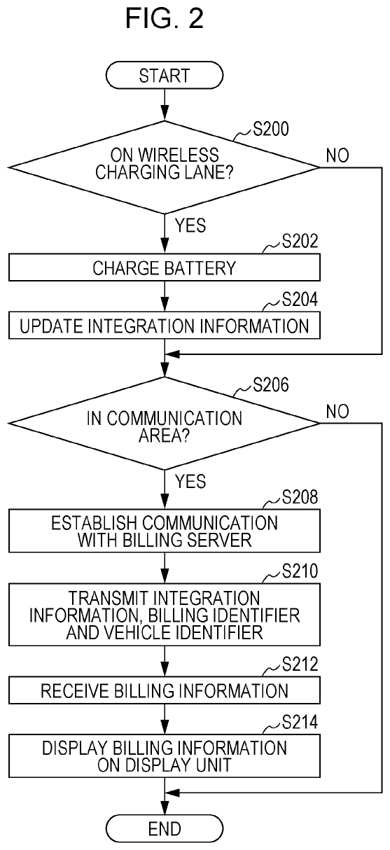

FIG. 2 is a flowchart illustrating the flow of a charging management method. The charging management method is repeatedly executed at each interruption cycle.

First, the onboard charger 32 determines whether the vehicle 14 is on the wireless charging lane (S200). If the vehicle 14 is outside the wireless charging lane (NO in S200), the procedure proceeds to step 5206.

If the vehicle 14 is on the wireless charging lane (YES in S200), the onboard charger 32 receives electricity via the power receiving coil 30, and charges the battery 34 (S202). Then, the electricity integrator 38 integrates the amount of electricity used for charging the battery 34, and updates the integration information (S204).

Subsequently, the vehicle communication unit 40 determines whether the vehicle 14 is in the communication area where communication with the management server of ETC 2.0 can be established (S206). If the vehicle 14 is outside the communication area (NO in S206), the charging management method ends.

If the vehicle 14 is in the communication area (YES in S206), the vehicle communication unit 40 establishes wireless communication with the management server of ETC 2.0, and establishes communication with the billing server 16 via the management server of ETC 2.0 (S208). Then, the vehicle communication unit 40 transmits the integration information, the billing identifier, and the vehicle identifier to the billing server 16 (S210). If billing information is generated in the billing server 16, the vehicle communication unit 40 receives the billing information from the billing server 16 via the management server of ETC 2.0 (S212). Then, the vehicle communication unit 40 displays the billing information acquired by the vehicle communication unit 40, on the display unit 42 (S214), and the charging management method ends.

With this configuration, the vehicle 14 itself can determine the amount of electricity with which the vehicle 14 is actually charged. Therefore, the exact amount of electricity used for charging can be determined even when the amount of electricity with which the battery 34 is charged varies depending on the position and attitude of the vehicle 14.

Further, it is possible to transmit the integration information to the billing server 16 via a high-security communication path, so that billing can be appropriately performed.

A program for causing a computer to function as the charging management system 10, and a computer-readable storage medium, such as flexible disk, magneto-optical disk, ROM, CD, DVD, and BD, storing the program are also provided. The term “program” as used herein refers to a data processor described in a suitable language and with a suitable description method.

While the preferred embodiment of the disclosure has been described with reference to the accompanying drawings, it is understood that the embodiment does not limit the disclosure. It is apparent to those skilled in the art that various changes and modifications may be made without departing from the scope of the disclosure, and such changes and modifications fall within the technical scope of the disclosure.

For example, in the above embodiment, operations such as transmitting the integration information, the billing identifier, and the vehicle identifier to the billing server 16 and displaying the received billing information on the display unit 42 are mainly performed by the vehicle communication unit 40. However, the disclosure is not limited thereto, and various operations may be mainly performed by the display unit 42.

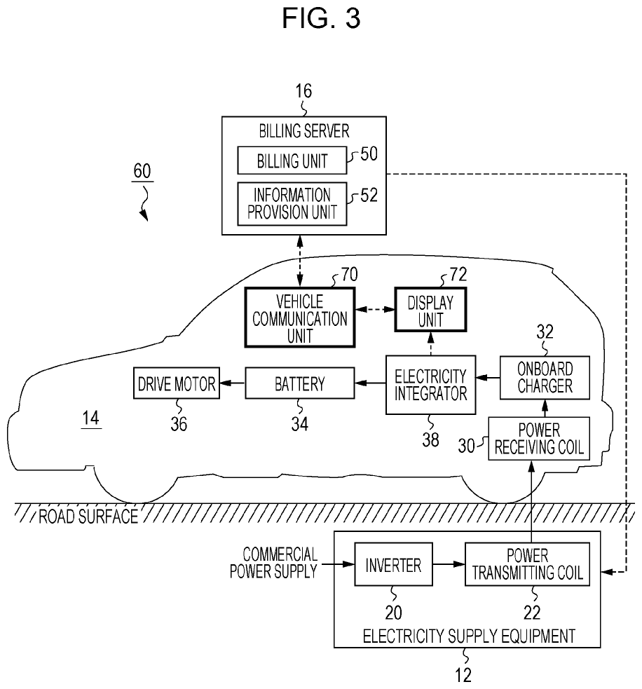

FIG. 3 is a block diagram schematically illustrating the configuration of a charging management system 60. Similar to the charging management system 10, the charging management system 60 includes electricity supply equipment 12, a vehicle 14, and a billing server 16. The charging management system 60 differs from the charging management system 10 uniquely in the configuration of a vehicle communication unit 70 and a display unit 72. Therefore, the following mainly describes the differences, and a detailed description of the other function units already described in relation to the charging management system 10 will not be given here.

The display unit 72 is coupled to the electricity integrator 38 by wire such as CAN communication. The display unit 72 transmits integration information received from the electricity integrator 38 to the billing server 16 via the vehicle communication unit 70 coupled by wire, together with a billing identifier and a vehicle identifier. Further, the display unit 72 displays billing information acquired via the vehicle communication unit 70.

The steps of the charging management method described herein are not necessarily processed in chronological order described in the flowchart, and may be performed in parallel or may include sub-routine processing.

According to the disclosure, it is possible to determine an amount of electricity with which a vehicle is actually charged, and to appropriately perform billing.

1. A charging management system comprising:
a battery rechargeable with electricity;
an onboard charger configured to supply electricity wirelessly received to the battery; and
an electricity integrator configured to integrate an amount of electricity used for charging the battery.

2. The charging management system according to claim 1, further comprising
a vehicle communication unit that transmits integration information indicating the amount of electricity integrated by the electricity integrator to a billing server, together with a billing identifier for identifying a billing destination, wherein
the billing server bills the billing destination identified by the billing identifier, on a basis of the integration information.

3. The charging management system according to claim 2, further comprising
a display unit, wherein
the vehicle communication unit acquires billing information from the billing server, and
the display unit displays the billing information acquired by the vehicle communication unit in a manner such that the billing information is recognizable by a driver.
